(19) United States
(12) Patent Application Publication
(10) Pub. No.: US 2025/0182102 A1
(43) Pub. Date: Jun. 5, 2025

(54) SYSTEM AND METHOD FOR MONITORING AND SUSPENDING SMART CONTRACTS

(71) Applicant: APPLIED BLOCKCHAIN LTD, London (GB)

(72) Inventor: Adi BEN ARI, London (GB)

(21) Appl. No.: 19/043,495

(22) Filed: Feb. 2, 2025

Related U.S. Application Data
(63) Continuation of application No. PCT/IL2023/050768, filed on Jul. 24, 2023.
(60) Provisional application No. 63/394,428, filed on Aug. 2, 2022.

(51) Int. Cl. G06Q 20/38; G06Q 20/40

(52) U.S. Cl. CPC G06Q 20/3825; G06Q 20/38215; G06Q 20/401

(57) ABSTRACT

The present invention relates to a system and method for enhancing the security of smart contracts within blockchain networks by utilizing a hardware secure enclave for monitoring and suspending contract activities in response to detected security breaches. The system establishes a trust relationship between the hardware secure enclave and the smart contract, providing the smart contract with a unique enclave signature to ensure secure communications. A modular data monitoring application within the enclave is configured to detect suspicious activities, while an attestation process ensures the integrity of the enclave's code. Upon detecting a security threat, the system initiates a pause function to suspend contract operations and mitigate potential damage. The invention further leverages blockchain relayer modules to witness and transmit contract activity, and consensus mechanisms such as Proof-of-Work (PoW) or Proof-of-Stake (PoS) for transaction verification. This method provides a scalable, secure solution for preventing attacks on smart contracts and safeguarding digital assets in decentralized applications.

### CROSS REFERENCE TO RELATED APPLICATIONS

This application is a continuation of PCT Patent Application No. PCT/IL2023/050768 having International filing date of Jul. 24, 2023, which claims the benefit of priority of U.S. Provisional Patent Application No. 63/394,428, filed Aug. 2, 2022, the contents of which are all incorporated herein by reference in their entirety

### FIELD OF THE INVENTION

The present invention relates to the field of internet security, more particularly to methods and systems for enhancing the security of smart contracts in blockchain networks.

### BACKGROUND OF THE INVENTION

Smart contracts are programs stored on a blockchain that run when predetermined conditions are met. They are typically used to automate the execution of an agreement so that all participants can be immediately certain of the outcome, without any intermediary's involvement or time loss. Smart contracts can also automate a workflow, triggering the next action when conditions are met. Smart contracts include a “pause” function that suspends all activity in the case of a security breach

An example of a pause function is the self-destruct function provided by Ethereum smart contracts to destroy a contract on the blockchain system. However, it is a double-edged sword for developers. On the one hand, using a self-destruct function enables developers to remove smart contracts (SC) from Ethereum and transfers Ethers when emergency situations happen, e.g., being attacked. On the other hand, this function can increase the complexity for the development and open an attack vector for attackers, such as described in the following reference:
Why Do Smart Contracts Self-Destruct? Investigating the Self-destruct Function on Ethereum* JIACHI CHEN, Monash University ACM Trans. Softw. Eng. Methodol., Vol. 1, No. 1, Article 1. Publication date: January 2021.

LifeScope detects the self-destruct issues at source code level, which utilizes AST (abstract syntax tree) to parse the smart contracts and extract related information to detect Unmatched ERC20 Standard. For Limits of Permission, LifeScope first transfers the contract to a TF-IDF representation and then utilizes machine learning algorithms to predict this problem. These two problems are not only limited to contracts that contain the self-destruct function. Any smart contracts can be analyzed with LifeScope to detect these two problems before deploying them to the Ethereum. This solution runs monitoring code outside the blockchain to detect suspicious activity and then uses an administrator key to pause activity. LifesScope and similar solutions use Machine learning for detecting suspicious activity which is often complex and is therefore not suitable for running inside blockchain smart contracts, and is therefore run by default outside the blockchain. The problem with this approach is that the administrator key itself has the power to pause the smart contracts and freeze funds and activities mid-flight, and this poses an additional target which may not have existed before.

In US11042804B2 (Kikinis) there is provided a system and method providing a security gateway for high security blockchain systems, that acts as a firewall (and manages users, rules, data access, transactions, fees, etc.), has the ability to understand and enforce blockchain business process policies (access policy and transaction policy of a blockchain solution that may or may not support smart contracts), and can understand tokens and their functionality, without totally disabling code execution, for example from smart contracts or tokens enabled by smart contracts. Such a system, however, is complex and multi-tiered.

In light of the above, there is a long felt and unmet need for systems and methods for monitoring attacks on smart contracts and suspending smart contracts when appropriate (see reference: https://www.ledger.com/soft-launching-ledger-sgx-enclave).

### SUMMARY OF THE INVENTION

The present invention relates to a computer-implemented system and method for monitoring and suspending smart contracts within a blockchain network, utilizing a hardware secure enclave to detect and respond to potential security breaches. The system is designed to enhance the security and integrity of decentralized applications by securely monitoring smart contract activities, detecting suspicious behavior, and automatically pausing contract operations if a security threat is identified. This invention aims to address the vulnerabilities inherent in blockchain-based smart contracts by ensuring that any security issues are promptly addressed in a secure and tamper-proof manner, thereby safeguarding valuable digital assets and preventing malicious interference. By leveraging a hardware secure enclave, blockchain relayer modules, and consensus mechanisms such as Proof-of-Work (PoW) or Proof-of-Stake (PoS), the invention provides a robust and scalable solution for securing smart contract operations and mitigating risks associated with blockchain-based transactions.

It is an objective of the present invention to disclose a method for monitoring and suspending smart contracts in blockchain, comprising steps of:
a. establishing, by at least one processor and non-transitory computer readable medium of a scalable server system, a trust relationship between a hardware secure enclave of said server system and a smart contract; said non-transitory computer readable medium storing machine-readable instructions executable by said at least one processor;
b. providing, by said hardware secure enclave, said smart contract with a unique enclave signature enabling calls based on said unique enclave signature to be accepted;
c. configuring, by said at least one processor, a modular data monitoring application within said hardware secure enclave;
d. including, by said at least one processor, a specific pre-defined monitoring code indicating an instruction of a pause function configured to suspend any smart contract activity in case of a security breach;
e. submitting, by said hardware secure enclave, an attestation request to a processor manufacturer attestation module;
f. relaying and witnessing, by a blockchain relayer module, blockchain smart contract activity to said hardware secure enclave;
g. verifying, by a light client, a transaction from said blockchain;
h. monitoring, by said data monitoring application, data from said blockchain relayer module;
i. detecting, by said data monitoring application, suspicious activity in said smart contract; and,
j. initiating, by said at least one processor, said pause function.

It is an objective of the present invention to disclose the aforementioned method, wherein verifying the transaction requires state proofs selected from the group consisting of Proof-of-Work (PoW), Proof-of-Stake (PoS), consortium proofs, private proofs, or any other consensus mechanism.

It is an objective of the present invention to disclose the aforementioned method, wherein verifying the transaction is carried out via a light client.

It is an objective of the present invention to provide a system for monitoring and suspending smart contracts in blockchain, comprising:
a. a scalable server system, comprising:
   i. at least one computer-readable memory;
   ii. at least one computer-readable medium (CRM);
   iii. at least one processor;
   iv. a hardware secure enclave implemented within said at least one processor;
   v. a data monitoring application implemented within said hardware secure enclave; and,
   vi. machine-readable instructions stored on said at least one CRM for execution by said at least one processor via said at least one memory, configured to:
      1) establish a trust relationship between said hardware secure enclave and a smart contract of a blockchain network;
      2) provide said smart contract with a unique enclave signature enabling calls based on said unique enclave signature to be accepted;
      3) include a specific pre-defined monitoring code indicating an instruction of a pause function configured to suspend any smart contract activity in case of a security breach;
      4) submit an attestation request to a processor manufacturer attestation module;
      5) receive data related to blockchain smart contract activity from a blockchain relayer module;
      6) receive verification from a light client of a blockchain transaction;
      7) detect suspicious activity in said smart contract; and,
      8) initiate said pause function.

It is an objective of the present invention to provide the aforementioned system, wherein the hardware secure enclave is configured to submit an attestation request for enclave and application source code hash.

It is an objective of the present invention to provide the aforementioned system, wherein the system comprises a blockchain relayer module for witnessing and transmitting data on blockchain smart contract activity to the hardware secure enclave.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 provides an illustration of the basic elements of the present invention, in accordance with an embodiment of the present disclosure.

FIG. 2 provides an illustration of aspects of the present invention, in accordance with an embodiment of the present disclosure.

### DETAILED DESCRIPTION OF THE PREFERRED EMBODIMENTS

For the purposes of promoting an understanding of the principles of the invention, reference will now be made to the embodiments illustrated in the figures and specific language will be used to describe the same. While examples and features of disclosed principles are described herein, modifications, adaptations, and other implementations are possible without limitation of the scope of the disclosed embodiments. Any further applications of the principles as described herein are contemplated as would normally occur to one skilled in the art.

This disclosure employs open-ended permissive language, indicating for example, that some embodiments “may” employ, involve, or include specific features. The use of the term “may”, and other open-ended terminology is intended to indicate that although not every embodiment may employ the specific disclosed feature, at least one embodiment employs the specific disclosed feature.

In the following description, it is to be understood that the present disclosure may be practiced without one or more of the following details. Reference will now be made in detail to non-limiting examples of this disclosure, examples of which are illustrated in the accompanying figures. The examples are described below by referring to the figures, wherein like reference numerals refer to like elements. When similar reference numerals are shown, corresponding description(s) are not repeated, and the interested reader is referred to the previously discussed figure(s) for a description of the like element(s).

Various embodiments are described herein with reference to a system(s) and method(s). It is intended that the disclosure of one is a disclosure of all. For example, it is to be understood that disclosure of a system described herein also constitutes a disclosure of the method implemented by the system, via, for example, one or more processors. It is to be understood that this form of disclosure is for ease of discussion only, and one or more aspects of one embodiment herein may be combined with one or more aspects of other embodiments herein, within the intended scope of this disclosure.

Blockchain smart contacts present a method for managing, holding, transferring and generally applying business logic to digital assets (also known as tokens) stored in a distributed ledger (also known as a blockchain).

The advantages of smart contracts include the fact that they operate relatively autonomously. The smart contracts are executed and validated by the nodes that comprise a blockchain 110 network. Typically, all nodes in a network must execute and agree on the validity and results of the smart contract execution in order for the execution to be accepted and for the results of the smart contract execution to update the state of the assets registered in the blockchain ledger.

Smart contracts also present a challenge, in that, because they are comprised of code that handles digital assets relatively autonomously, any errors, bugs or vulnerabilities in the smart contract code offer a potential attacker access to the digital assets, often valued at tens or hundreds of millions of dollars (see Parity error, Wormhole attack, etc.).

In order to mitigate such attacks, smart contract developers try to use proven, well tested code, as well as code analysis tools in order to identify any vulnerabilities ahead of deployment. Smart contract code security audits are performed by third parties in order to further identify vulnerabilities.

Once the smart contract code is deployed and begins to transact and store value on a blockchain, any vulnerabilities that remain will be difficult to detect, and if an attacker does begin an attack, it will be difficult to identify or halt such an attack before a significant number of funds or assets have been compromised.

In the cybersecurity realm, numerous machine and network scanning tools are available to monitor and detect unusual behaviour by potential attackers, alert, and automatically halt access or halt systems in order to mitigate the damage of a potential attack.

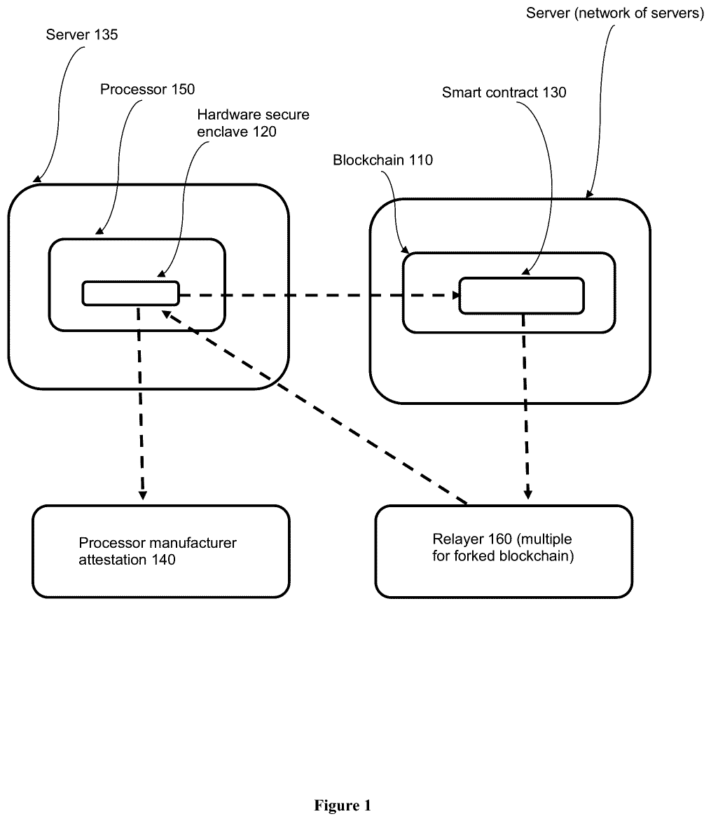

In the present invention, FIG. 1 illustrates a system and method for making blockchain smart contracts more secure. The smart contracts are monitored by a monitoring code running inside a hardware secure enclave 120 that cannot be modified without the smart contract itself being modified first. Only if an issue is detected by the enclaved monitoring code, is the contract paused or suspended.

### Definitions

The term “Secure Enclave” is herein described with particular relevance to the present invention.

A secure enclave provides central processing unit (CPU) hardware-level isolation and memory encryption on every server, by isolating application code and data from anyone with privileges, and encrypting its memory. With additional software, secure enclaves enable the encryption of both storage and network data for simple full stack security. Secure enclave hardware support is built into all new CPUs from Intel and AMD.

Enclaves are solutions which are built into the CPU and provide hardware security. Using a dedicated set of instruction codes, enclaves are isolated regions of memory which are protected from processes running at any privilege level, including the operating system.

The term and product “Intel Software Guard Extensions (SGX)” is herein described with particular relevance to the present invention.

Intel Software Guard Extensions (SGX) is a set of security-related instruction codes that are built into some Intel CPUs. They allow user-level and operating system code to define private regions of memory, called enclaves, whose contents are inaccessible from the outside. SGX is designed to be useful for implementing secure remote computation, secure web browsing, and digital rights management (DRM). Other applications include concealment of proprietary algorithms and of encryption keys. SGX involves encryption by the CPU of a portion of memory (the enclave).

SGX involves encryption by the CPU of a portion of memory (the enclave). Data and code originating in the enclave are decrypted on the fly within the CPU, protecting them from being examined or read by other code, including code running at higher privilege levels such the operating system and any underlying hypervisors, thus mitigating many kinds of attacks.

The terms “witnessing or witness” are herein defined as signatures attesting to authenticity of data. An example would be a bitcoin transaction in which the witness is the contents of the signature scripts, which are what proves that the transaction is authentic.

The terms “pausing, pause, pause function, suspend or suspending” are used interchangeably and are explained briefly below:

“Pausing” or “suspending” a smart contract:

When a smart contract is “paused,” nothing can be done with it (it can't be transferred). Only the contract deployer can pause or unpause the contract. This individual can also add more “pauser” accounts to the contract.

In some use cases, disabling options are used on critical contract functionality in case of an emergency.

The term “Multisignature (multisig)” is used herein and briefly explained below:

Multisignature (multisig) wallets are smart contracts that allow multiple signers to review and agree on an action on the blockchain before the action is executed.

The term “Light clients” is defined herein:

Light clients or light nodes help users access and interact with a blockchain in a secure and decentralized manner without having to sync the full blockchain. A light client or light node is a piece of software that connects to full nodes to interact with the blockchain. Unlike their full node counterparts, light nodes don't need to run 24/7 or read and write a lot of information on the blockchain. Light clients do not interact directly with the blockchain; they instead use full nodes as intermediaries. Light clients rely on full nodes for many operations, from requesting the latest headers to asking for the balance of an account.

The term “Consensus mechanisms” are defined herein:

Consensus mechanisms of blockchain smart contract systems covered in the present invention in a non-limiting manner:

Blockchain systems vary considerably in their design, particularly with regard to the consensus mechanisms used to perform the essential task of verifying network data. The most common consensus mechanisms are Proof of Work (PoW), Proof of Stake (PoS), and methods used by private and consortium blockchains. Each design has different implications for the underlying blockchain's security, accessibility, and sustainability.

With POS, cryptocurrency owners validate block transactions based on the number of coins a validator stakes.

POS was created as an alternative to POW, the original consensus mechanism used to validate a blockchain and add new blocks.

A private blockchain is a blockchain controlled by a centralized entity which determines who can interact with the blockchain, verify transactions, and who can view the information recorded on the blockchain. A consortium blockchain is a distributed ledger controlled by several entities, each of which operates a network node, participates in consensus, and has permissions to view certain types of data.

The blockchain-based smart contract lacks privacy, since the contract state and instruction code are exposed to the public.

It is acknowledged herein that the core of the present invention is to provide a system and method ensuring that a suspend function or pause function of a smart contract within a blockchain can only be activated by a specific secure enclave (Intel SGX) instance running specific predefined monitoring code. Combining smart-contract execution with Trusted Execution Environments (TEE) provides an efficient solution, called TEE-assisted smart contracts (TCSC), for protecting the confidentiality of contract states.

It is further acknowledged that any change to the secure enclave monitoring code requires a redeploy of the smart contract.

It is further acknowledged herein that if a contract code change affects monitoring, any change to the contract requires an update to the secure enclave monitoring code to resume smart contract activity following suspension, wherein a predefined administrator key (or multi-sig) is required.

It is acknowledged herein that the aforementioned system and method is useful for monitoring cybersecurity risks and token theft in smart contracts (e.g., DeFi liquidity pools) in order to trigger pausing of contracts suspected to be under attack.

It is further acknowledged herein that the system and method of the present invention is useful for monitoring general performance of DeFi (Decentralized Finance) and DAO (Decentralized

Autonomous Organization) smart contracts (e.g., balance of lending vs borrowing, collateral and pricing) in order to trigger behaviour in other contracts (e.g., investing strategies).

The method of the present invention is to run the monitoring code in a hardware secure enclave 120, such as Intel SGX. Such an environment includes a code and enclave attestation 140 feature, whereby the enclave manufacturer provides a cryptographic attestation that the enclave is theirs, and therefore the code signed by the enclave is therefore present in that enclave (represented by a hash of the enclave). This allows us to set up an enclave with a blockchain smart contract such that the smart contract will only trust a specific enclave running specific code. If the enclave code is modified, then the blockchain smart contract will no longer accept messages from that enclave.

In some embodiments of the system and method of the present invention, the integrity of the enclave's monitoring code is ensured by registering the attestation of this code in a blockchain smart contract. For instance, the cryptographic hash of the enclave's monitoring code is stored within the smart contract, allowing for verification. This ensures that when the pause function is triggered, it is only called by an enclave that has been attested as running the correct code. Upon invocation of the pause function, the smart contract performs a comparison, for instance compares the hash of the enclave's current code against the registered hash. If the code has been modified or is inconsistent with the registered version, the smart contract will reject the request, thereby preventing unauthorized actions and ensuring that only the verified code within the enclave is trusted to execute the pause functionality.

In further embodiments of the system and method of the present invention, the light client responsible for validating blockchain transactions operates within the hardware secure enclave. A blockchain relayer module transmits blockchain network messages to the enclave, where the light client processes the data and performs transaction validation. By embedding the light client within the secure enclave, the system ensures that the client's code is securely attested and protected from tampering. This configuration provides assurance that only validated, trusted blockchain data is used to drive the monitoring application and trigger the pause function when suspicious activity is detected. As a result, the entire process, from transaction verification to the execution of the pause function, is carried out within a secure and trusted environment.

Reference is now made to FIG. 1 disclosing a system for monitoring and suspending smart contracts 130 in blockchain 110, comprising:
a. a scalable server system 135, comprising:
   i. at least one computer-readable memory;
   ii. at least one computer-readable medium (CRM);
   iii. at least one processor 150;
   iv. a hardware secure enclave 120 implemented within said at least one processor 150;
   v. a data monitoring application implemented within said hardware secure enclave 120;
   vi. machine-readable instructions stored on said at least one CRM for execution by said at least one processor via said at least one memory, configured to:
      1) establish a trust relationship between said hardware secure enclave 120 and a smart contract 130 of a blockchain network 110;
      2) provide said smart contract 130 with a unique enclave signature enabling calls based on said unique enclave signature to be accepted;
      3) include a specific pre-defined monitoring code indicating an instruction of a pause function configured to suspend any smart contract activity in case of a security breach;
      4) submit an attestation request to a processor manufacturer attestation module 140;
      5) receive data related to blockchain smart contract activity from a blockchain relayer module 160;
      6) receive verification from a light client of a blockchain transaction;
      7) detect suspicious activity in said smart contract 130; and,
      8) initiate said pause function.

Reference is now made to the aforementioned system, wherein the hardware secure enclave is configured to submit an attestation request for enclave and application source code hash.

Reference is now made to the aforementioned system, wherein the system comprises a blockchain relayer module 160 for witnessing and transmitting data on blockchain smart contract activity to the hardware secure enclave.

Reference is made herein of a system characterized by a blockchain 110 smart contract 130, including an emergency “pause” function, that can only be called by a specific hardware secure enclave 120 containing specific monitoring code, using a key only present inside the hardware secure enclave 120. This prevents an attacker from accessing the key that could pause the smart contract 130, or from modifying or manipulating the monitoring code in order to attempt to attack the smart contract 130 by pausing it.

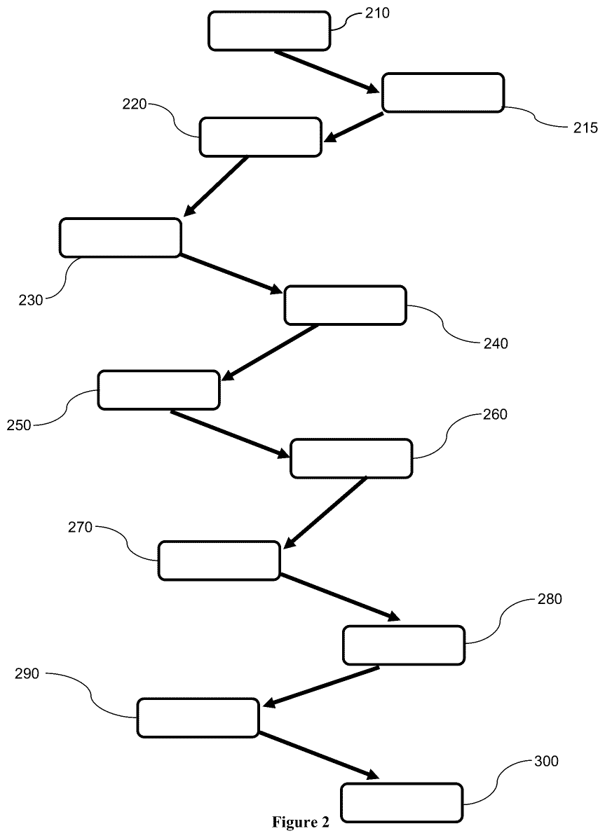

Reference is now made to FIG. 2 disclosing a method for monitoring and suspending smart contracts in blockchain, comprising steps of:
a. establishing 210, by at least one processor and non-transitory computer readable medium of a scalable server system, a trust relationship between a hardware secure enclave of said server system and a smart contract; said non-transitory computer readable medium storing machine-readable instructions executable by said at least one processor;
b. providing 215, by said hardware secure enclave, said smart contract with a unique enclave signature enabling calls based on said unique enclave signature to be accepted;
c. configuring 220, by said at least one processor, a modular data monitoring application within said hardware secure enclave;
d. including 230, by said at least one processor, a specific pre-defined monitoring code indicating an instruction of a pause function configured to suspend any smart contract activity in case of a security breach;
e. submitting 240, by said hardware secure enclave, an attestation request to a processor manufacturer attestation 140 module;
f. relaying 250 and witnessing 260, by a blockchain relayer module, blockchain smart contract activity to said hardware secure enclave;
g. verifying 270, by a light client, a transaction from said blockchain;
h. monitoring 280, by said data monitoring application, data from said blockchain relayer module;
i. detecting 290, by said data monitoring application, suspicious activity in said smart contract; and,
j. initiating 300, by said at least one processor, said pause function.

Reference is now made to an embodiment of the aforementioned method, wherein verifying the transaction requires state proofs selected from the group consisting Proof-of-Work (PoW), Proof-of-Stake (PoS), consortium proofs, private proofs, or any other consensus mechanism.

Reference is now made to an embodiment of the aforementioned method, wherein verifying the transaction is carried out via a light client.

1. A method for monitoring and suspending smart contracts in blockchain, comprising steps of:
a. establishing, by at least one processor and non-transitory computer readable medium of a scalable server system, a trust relationship between a hardware secure enclave of said server system and a smart contract; said non-transitory computer readable medium storing machine-readable instructions executable by said at least one processor;
b. providing, by said hardware secure enclave, said smart contract with a unique enclave signature enabling calls based on said unique enclave signature to be accepted;
c. configuring, by said at least one processor, a modular data monitoring application within said hardware secure enclave;
d. including, by said at least one processor, a specific pre-defined monitoring code indicating an instruction of a pause function configured to suspend any smart contract activity in case of a security breach;
e. submitting, by said hardware secure enclave, an attestation request to a processor manufacturer attestation module;
f. Relaying and witnessing, by a blockchain relayer module, blockchain smart contract activity to said hardware secure enclave;
g. verifying, by a light client, a transaction from said blockchain;
h. monitoring, by said data monitoring application, data from said blockchain relayer module;
i. detecting, by said data monitoring application, suspicious activity in said smart contract; and,
j. initiating, by said at least one processor, said pause function.

2. The method of claim 1, wherein said verifying said transaction requires state proofs selected from the group consisting of Proof-of-Work (PoW), Proof-of-Stake (PoS), consortium proofs, private proofs, or any other consensus mechanism.

3. The method of claim 2, wherein said verifying said transaction is carried out via a light client.

4. A system for monitoring and suspending smart contracts in blockchain, comprising:
a. a scalable server system, comprising:
i. at least one computer-readable memory;
ii. at least one computer-readable medium (CRM);
iii. at least one processor;
iv. a hardware secure enclave implemented within said at least one processor;
v. a data monitoring application implemented within said hardware secure enclave; and,
vi. machine-readable instructions stored on said at least one CRM for execution by said at least one processor via said at least one memory, configured to:
1) establish a trust relationship between said hardware secure enclave and a smart contract of a blockchain network;
2) provide said smart contract with a unique enclave signature enabling calls based on said unique enclave signature to be accepted;
3) include a specific pre-defined monitoring code indicating an instruction of a pause function configured to suspend any smart contract activity in case of a security breach;
4) submit an attestation request to a processor manufacturer attestation module;
5) receive data related to blockchain smart contract activity from a blockchain relayer module;
6) receive verification from a light client of a blockchain transaction;
7) detect suspicious activity in said smart contract; and,
8) initiate said pause function.

5. The system of claim 4, wherein said hardware secure enclave is configured to submit an attestation request for enclave and application source code hash.

6. The system of claim 4, wherein said system comprises a blockchain relayer module for witnessing and transmitting data on blockchain smart contract activity to said hardware secure enclave.
